(19) United States
(12) Patent Application Publication
(10) Pub. No.: US 2024/0234809 A1
(43) Pub. Date: Jul. 11, 2024

(54) SULFIDE-BASED SOLID ELECTROLYTE AND METHOD FOR MANUFACTURING SAME

(71) Applicant: AGC Inc., Tokyo (JP)

(72) Inventors: Naoki FUJII, Tokyo (JP); Riku KITAMURA, Tokyo (JP); Jinsuke MIYAKE, Tokyo (JP); Kosho AKATSUKA, Tokyo (JP)

(73) Assignee: AGC Inc., Tokyo (JP)

(21) Appl. No.: 18/617,754

(22) Filed: Mar. 27, 2024

Related U.S. Application Data
(63) Continuation of application No. PCT/JP2022/024589, filed on Jun. 20, 2022.

(30) Foreign Application Priority Data
Sep. 30, 2021 (JP) 2021-161522

(51) Int. Cl. H01M 10/0562; H01M 10/0525

(52) U.S. Cl. CPC H01M 10/0562; H01M 10/0525; H01M 2300/008

(57) ABSTRACT

The present invention relates to a sulfide solid electrolyte to be used for a lithium-ion secondary battery. The sulfide solid electrolyte contains: an argyrodite crystal containing Li, P, S, and Ha (F, Cl, Br, and I). Relationships of {(1/χ_{(S)})×[S²⁻]₀+(1/χ_{(O)})×[O²⁻]₀+(1/χ_{(Br)})×[Br⁻]₀+(1/χ_{(Cl)})×[Cl⁻]₀+(1/χ_{(F)})×[F⁻]₀}≤0.33 and [S²⁻]₀+[O²⁻]₀+[Br⁻]₀+[Cl⁻]₀+[F⁻]₀=1 are satisfied, where [S²⁻]₀, [O²⁻]₀, [Br⁻]₀, [Cl⁻]₀, and [F⁻]₀ are surface anion contents, and χ is an electronegativity thereof.

### CROSS-REFERENCE TO RELATED APPLICATIONS

This is a continuation of International Application No. PCT/JP2022/024589 filed on Jun. 20, 2022, and claims priority from Japanese Patent Application No. 2021-161522 filed on Sep. 30, 2021, the entire content of which is incorporated herein by reference.

### TECHNICAL FIELD

The present invention relates to a sulfide solid electrolyte to be use for a lithium-ion secondary battery and a method for manufacturing the sulfide solid electrolyte.

### BACKGROUND ART

Lithium-ion secondary batteries are widely used for a portable electronic device such as a mobile phone and a notebook computer.

In the related art, a liquid electrolyte has been used in a lithium-ion secondary battery, but there is a concern of liquid leakage, ignition, and the like, and it has been necessary to increase the size of a case for safety design. The lithium-ion secondary batteries have also been desired to be improved in terms of short battery life and narrow operating temperature range.

On the other hand, attention has been paid to an all-solid-state lithium-ion secondary battery in which a solid electrolyte is used as an electrolyte of a lithium-ion secondary battery, from the viewpoint of improving safety, charge and discharge at a high speed, and reducing the size of a case.

The solid electrolytes are roughly classified into sulfide solid electrolytes and oxide solid electrolytes. The sulfide ions constituting the sulfide solid electrolytes have higher polarizability and higher lithium ion conductivity than those of the oxide ions constituting the oxide solid electrolytes. As the sulfide solid electrolytes, LGPS crystals such as Li₁₀GeP₂S₁₂, argyrodite crystals such as Li₆PS₅Cl, LPS crystallized glasses such as Li₇P₃Su1 crystallized glass, and the like have been known.

Patent Literature 1 discloses a sulfide solid electrolyte containing an argyrodite crystal. The sulfide solid electrolyte disclosed in Patent Literature 1 has a cubic crystal structure belonging to a space group F-43m, and contains a compound represented by a composition formula: Li₇₋ₓPS_{6-X}Ha_{X} (where Ha represents Cl or Br) (where x=0.2 to 1.8), and a lightness L value of an L*a*b* color system is 60.0 or more. This is intended to improve the charge and discharge efficiency and the cycle characteristics by increasing the lithium ion conductivity and decreasing the electron conductivity.

In the case of using such a sulfide solid electrolyte for a lithium-ion secondary battery, when a positive electrode made of LiCoO₂ or a ternary system of nickel, manganese, and cobalt that is called NMC is used, the output characteristics and the discharge capacity decrease as the charge and discharge are repeated. This is due to an increase in interfacial resistance between the positive electrode active material and the sulfide solid electrolyte. On the other hand, Non Patent Literature 1 and Non Patent Literature 2 disclose that the above-described interfacial resistance can be reduced and the performance of an all-solid-state lithium-ion secondary battery can be improved by coating the surface of LiCoO₂, which is a positive electrode active material, with lithium niobate (LiNbO₃).

### CITATION LIST

### Patent Literature

Patent Literature 1: WO2015/012042

### Non-Patent Literature

Non Patent Literature 1: Solid State Ionics, Volume 225 (2012) Page 594-597
Non Patent Literature 2: Chemistry of Materials, 22(3) (2010) Page 949-956

### SUMMARY OF INVENTION

### Technical Problem

The ideal thickness of the surface coating using a coating agent such as LiNbO₃ with respect to the positive electrode active material is 7 nm to 10 nm, but it is difficult to apply such a very thin coating uniformly and with good reproducibility. In the case of using a spinel crystal LiNiₓMn₂₋ₓO₄, which is known as a high potential positive electrode active material, the coating agent such as LiNbO₃ may not be suitable for the surface coating since it cannot withstand high electromotive force and decomposes.

Therefore, an object of the present invention is to provide a sulfide solid electrolyte that prevents deterioration in battery characteristics during repeated charging and discharging without coating the surface of a positive electrode active material such as LiCoO₂ or NMC, and a method for manufacturing the sulfide solid electrolyte.

### Solution to Problem

As a result of intensive studies, the present inventors have found that deterioration in battery characteristics during repeated charging and discharging can be prevented by adopting, as a sulfide solid electrolyte, an argyrodite crystal, which has a feature of being able to be substituted with various elements, and dissolving a component that cannot be dissolved in the related art. Further, the inventors have found that the deterioration in battery characteristics can be further prevented by making a surface anion composition of the sulfide solid electrolyte appropriate, and have completed the present invention.

That is, the present invention relates to the following [1] to [12].

[1] A sulfide solid electrolyte to be used for a lithium-ion secondary battery, the sulfide solid electrolyte containing:
an argyrodite crystal containing Li, P, S, and Ha, in which
the Ha represents at least one element selected from the group consisting of F, Cl, Br, and I, including at least one of Cl and Br, and
the following relationships are satisfied, where [S²⁻]₀, [O²⁻]₀, [Br⁻]₀, [Cl⁻]₀, and [F⁻]₀ are surface anion contents of the sulfide solid electrolyte, and χ_{(S)}, χ_{(O)}, χ_{(Br)}, χ_{(Cl)}, and χ_{(F)} are electronegativities thereof:

{(1/χ_{(S)})×[S²⁻]₀+(1/χ_{(O)})×[O²⁻]₀+(1/χ_{(Br)})×[Br⁻]₀+(1/χ_{(Cl)})×[Cl⁻]₀+(1/χ_{(F)})×[F⁻]_{0}≤}0.33, and

[S²⁻]₀+[O²⁻]₀+[Br⁻]₀+[Cl⁻]₀+[F⁻]₀=1.

[2] The sulfide solid electrolyte according to the above [1], in which the sulfide solid electrolyte contains O and F.

[3] The sulfide solid electrolyte according to the above [1] or [2], in which the sulfide solid electrolyte contains 0, and the [O²⁻]₀ among the surface anion contents is 0.3 or more.

[4] The sulfide solid electrolyte according to any one of the above [1] to [3], in which the sulfide solid electrolyte contains F, and the [F⁻]₀ among the surface anion contents is 0.02 or more.

[5] The sulfide solid electrolyte according to any one of the above [1] to [4], in which the value represented by {(1/χ₍ₛ₎)×[S²⁻]₀+(1/χ_{(O)})×[O²⁻]₀+(1/χ_{(Br)})×[Br⁻]₀+(1/χ_{(Cl)})×[Cl⁻]₀+(1/χ_{(F)})×[F⁻]₀} is 0.31 or less.

[6] The sulfide solid electrolyte according to any one of the above [1] to [5], in which the sulfide solid electrolyte has a particle diameter D₅₀ of 0.6 μm or less.

[7] The sulfide solid electrolyte according to any one of the above [1] to [6], in which the following relationship is satisfied, where D₁₀, D₅₀, and D₉₀ are particle diameters of the sulfide solid electrolyte:

2.0≤{(D₁₀+D₉₀)/D₅₀}≤4.5.

[8] The sulfide solid electrolyte according to any one of the above [1] to [7], in which five or more kinds of internal anions are present in the sulfide solid electrolyte.

[9] The sulfide solid electrolyte according to any one of the above [1] to [8], in which the sulfide solid electrolyte contains O,

[S²⁻]_{bulk}+[O²⁻]_{bulk}+[Br⁻]_{bulk}+[Cl⁻]_{bulk}+[F⁻]_{bulk}=1 is satisfied, where [S²⁻]_{bulk}, [O²⁻]_{bulk}, [Br⁻]_{bulk}, [Cl⁻]_{bulk}, and [F⁻]_{bulk} are internal anion contents of the sulfide solid electrolyte, and
the [O²⁻]₀ among the surface anion contents is larger than the [O²⁻]_{bulk} among the internal anion contents, and a difference thereof is 0.2 or more.

[10] The sulfide solid electrolyte according to any one of the above [1] to [9], in which [S²⁻]_{bulk}+[O²]_{bulk}+[Br⁻]_{bulk}+[Cl⁻]_{bulk}+[F⁻]_{bulk}=1 is satisfied, where [S²⁻]_{bulk}, [O²⁻]_{bulk}, [Br⁻]_{bulk}, [Cl⁻]_{bulk}, and [F⁻]_{bulk} are the internal anion contents of the sulfide solid electrolyte, and
a value represented by {(1/χ_{(S)})×[S²⁻]_{bulk}+(1/χ_{(O)})×[O²⁻]_{bulk}+(1/χ_{(Br)})×[Br⁻]_{bulk}+(1/χ_{(Cl)})×[Cl⁻]_{bulk}+(1/χ_{(F)})×[F⁻]_{bulk}}using the internal anion contents and the electronegativities thereof χ_{(S)}, χ_{(O)}, χ_{(Br)}, χ(Cl), and χ_{(F)} is larger than the value represented by the {(1/χ_{(S)})×[S²]₀+(1/χ_{(O)})×[O²⁻]₀+(1/χ_{(Br)})×[Br⁻]₀+(1/χ_{(Cl)})×[Cl⁻]₀+(1/χ_{(F)})×[F]₀}, and a difference thereof is 0.01 or more.

[11] The sulfide solid electrolyte according to any one of the above [1] to [10], in which the surface anion contents satisfy a relationship of [O²⁻]₀>[S²⁻]₀.

[12] The sulfide solid electrolyte according to any one of the above [1] to [11], in which the surface anion contents satisfy a relationship of {[F⁻]₀/([Br⁻]₀+[Cl⁻]₀)}>0.02.

[13] The sulfide solid electrolyte according to any one of the above [1] to [12], in which an electromotive force of the lithium-ion secondary battery is 4.3 V or more.

[14] A method for manufacturing a sulfide solid electrolyte to be used for a lithium-ion secondary battery, the method including:
mixing raw materials containing Li, P, S, and Ha to obtain a raw material mixture; heating the raw material mixture to obtain a molten material as an intermediate compound;
cooling the molten material to precipitate an argyrodite crystal; and
subjecting the crystal to a heat treatment; wherein
in the crystal, S, at least one of Cl and Br, and one or two or more elements different from S and at least one of Cl and Br are present in an anion site, and
the heat treatment is performed under an atmosphere containing oxygen.

[15] The method for manufacturing a sulfide solid electrolyte according to the above [14], in which
an oxygen concentration in the heat treatment is 5 ppm to 5 vol %.

[16] The method for manufacturing a sulfide solid electrolyte according to the above [14] or [15], in which
a dew point in the heat treatment is −60° C. to −30° C.

### Advantageous Effects of Invention

According to the sulfide solid electrolyte of the present invention, deterioration in battery characteristics during repeated charging and discharging can be prevented without coating the surface of a positive electrode active material with LiNbO₃ or the like. Therefore, when the positive electrode active material is used for a lithium-ion secondary battery, the sulfide solid electrolyte eliminates the need for a step of applying a very thin coating to the surface of the positive electrode active material uniformly and with good reproducibility. Even when using a spinel crystal LiNiₓMn₂₋ₓO₄, which is known as a high potential positive electrode active material, it can be applied without concern about decomposition of the coating agent or the like.

### DESCRIPTION OF EMBODIMENTS

Hereinafter, the present invention will be described in detail, but the present invention is not limited to the following embodiment and can be freely modified and implemented without departing from the gist of the present invention. In addition, the symbol “-” or the word “to” that is used to express a numerical range includes the numerical values before and after the symbol or the word as the lower limit value and the upper limit value of the range, respectively.

### <Sulfide Solid Electrolyte>

A sulfide solid electrolyte according to the present embodiment (hereinafter, may be simply referred to as a “solid electrolyte”) is used for a lithium-ion secondary battery and contains an argyrodite crystal containing Li, P, S, and Ha. Ha represents at least one element selected from the group consisting of F, Cl, Br, and I. The argyrodite crystal in the present embodiment contains at least one of Cl and Br.

The following relationships are satisfied, where [S²⁻]₀, [O²⁻]₀, [Br⁻]₀, [Cl⁻]₀, and [F⁻]₀ are surface anion contents of the sulfide solid electrolyte according to the present embodiment, and χ_{(S)}, χ_{(O)}, χ_{(Br)}, χ_{(Cl)}, and χ_{(F)} are anion electronegativities.

{(1/χ₍ₛ₎)×[S²⁻]₀+(1/χ_{(O)})×[O²⁻]₀+(1/χ_{(Br)})×[Br⁻]₀+(1/χ_{(Cl)})×[Cl⁻]₀+(1/χ_{(F)})×[F⁻]₀}≤0.33 and

[S²⁻]₀+[O²⁻]₀+[Br⁻]₀+[Cl⁻]₀+[F⁻]₀=1

Hereinafter, {(1/χ_{(S)})×[S²⁻]₀+(1/χ_{(O)})×[O²⁻]₀+(1/χ_{(Br)})×[Br⁻]₀+(1/χ_{(Cl)})×[Cl⁻]₀+(1/χ_{(F)})×[F⁻]₀} may be referred to as a “surface anion parameter”. The electronegativity of each element in the surface anion parameter is χ_{(S)=}2.5, χ_{(O)}=3.5, χ_{(Br)}=2.8, χ_{(Cl)}=3.0, and χ_{(F)}=4.0.

In the present description, the surface of the sulfide solid electrolyte means a position at a depth of 50 nm from the outermost surface. This is because accurate composition analysis is difficult to perform on the outermost surface due to the influence of adsorbed substances, and thus the surface is determined as a position that is less susceptible to the influence of the adsorbed substances and is closer to the outermost surface. The composition at a depth of 50 nm from the outermost surface is analyzed by composition analysis (XPS analysis) using X-ray photoelectron spectroscopy to be described later.

With respect to internal anions of the sulfide solid electrolyte, similar to the surface anions, the following expression represented by using internal anion contents [S²⁻]_{bulk}, [O²⁻]_{bulk}, [Br⁻]_{bulk}, [Cl⁻]_{bulk}, and [F⁻]_{bulk} and anion electronegativities χ_{(S)}, χ_{(O)}, χ_{(Br)}, χ_{(Cl)}, and χ_{(F)} is referred to as an “internal anion parameter”.

{(1/χ_{(S)})×[S²⁻]_{bulk}+(1/χ_{(O)})×[O²⁻]_{bulk}+(1/χ_{(Br)})×[Br⁻]_{bulk}+(1/χ(c1))×[Cl⁻]_{bulk}+(1/χ_{(F)})×[F⁻]_{bulk}}

For the internal anion contents, [S²⁻]_{bulk}+[O²⁻]_{bulk}+[Br⁻]_{bulk}+[Cl⁻]_{bulk}+[F⁻]_{bulk}=1 is satisfied.

A value of the electronegativity of each element in the internal anion parameter is the same as the value of the electronegativity of each element in the surface anion parameter.

In the present description, a bulk composition of the sulfide solid electrolyte is an entire composition of the sulfide solid electrolyte that is determined by a composition analysis method to be described later.

The argyrodite crystal containing at least one of Cl and Br as Ha has a feature of being able to be substituted with various elements as a sulfide solid electrolyte, and can dissolve a component that cannot be dissolved in the related art. For example, O may be substituted into an anion site where S is originally present, or Br or F may be substituted into an anion site where Cl is originally present. Accordingly, desired characteristics are easily obtained.

When an element other than S, Cl, and Br is present in the anion site constituting the argyrodite crystal, the internal anion parameter of the sulfide solid electrolyte becomes smaller. Accordingly, the surface anion parameter of the sulfide solid electrolyte also becomes smaller.

The sulfide solid electrolyte according to the present embodiment preferably contains at least one of O and F, and more preferably contains O and F. O or F may be contained as an element constituting the argyrodite crystal, or may be contained as an element not constituting the argyrodite crystal. Alternatively, O or F may be contained in both element constituting the crystal and element not constituting the crystal.

In the sulfide solid electrolyte according to the present embodiment, since the surface anion parameter is 0.33 or less, deterioration in battery characteristics can be significantly prevented without deteriorating the lithium ion conductivity.

O and F have an electronegativity higher than that of S, Cl, and Br, and are components that lower the surface anion parameter. That is, the sulfide solid electrolyte according to the present embodiment preferably contains at least one of O and F, since the surface anion parameter can be easily decreased, and the deterioration in battery characteristics can be significantly prevented even when the surface of a positive electrode active material is not coated with LiNbO₃ or the like.

The reason why the effect of the present invention can be obtained when the surface anion parameter is 0.33 or less is not clear, and is considered as follows.

When a lithium-ion secondary battery using a positive electrode active material whose surface is not coated is charged and discharged, components are mutually diffused at an interface between the positive electrode active material and the sulfide solid electrolyte. As a result, an oxidation reaction, strictly speaking, a reaction between oxygen of the positive electrode active material and a sulfide of the solid electrolyte, or the like occurs on a sulfide solid electrolyte side. One of the causes of the oxidation reaction may be free anions, that is, unstable ions that are not covalently bonded to other elements, such as, particularly, S²⁻. It is considered that when the free anion is formed of an element having a high electronegativity as much as possible, a gap between an upper end of a valence band and a lower end of a conduction band becomes large, and the oxidation reaction is less likely to occur in a high potential state, accordingly, a good solid electrolyte interface (SEI) is formed at the interface between the positive electrode active material and the sulfide solid electrolyte, and therefore, the deterioration in battery characteristics can be prevented.

From the viewpoint of obtaining the above effect, the surface anion parameter is 0.33 or less, preferably 0.32 or less, and more preferably 0.31 or less. Since the smaller the surface anion parameter, the better, the lower limit is not particularly limited, and the surface anion parameter is generally 0.29 or more.

In order to reduce the surface anion parameter, a method of reducing the internal anion parameter by increasing an amount of a component having a high electronegativity in the bulk composition of the sulfide solid electrolyte, a method of subjecting the obtained sulfide solid electrolyte to a post-treatment, and the like can be mentioned. As the post-treatment, a method of performing a heat treatment under an atmosphere containing oxygen, a gas treatment such as an ozone treatment, an UV treatment, a plasma treatment, and the like are considered.

In the case of decreasing the surface anion parameter, when subjecting the obtained sulfide solid electrolyte to the post-treatment, it is preferable to perform the post-treatment after reducing the particle diameter of the sulfide solid electrolyte, from the viewpoint of increasing the post-treatment efficiency.

Specifically, the particle diameter D₅₀ before the post-treatment is preferably 5 μm or less, more preferably 2 μm or less, still more preferably 1 m or less, and particularly preferably 0.6 μm or less. The lower limit value of the particle diameter D₅₀ is not particularly limited, and the particle diameter D₅₀ is preferably 0.1 μm or more, and more preferably 0.3 m or more, from the viewpoint of ease of handling.

The smaller the particle diameter of the sulfide solid electrolyte after the post-treatment, the easier the sulfide solid electrolyte is to become dense when the sulfide solid electrolyte is made into a battery, which is preferable. The particle diameter D₅₀ after the post-treatment is preferably 5 μm or less, more preferably 2 μm or less, still more preferably 1 μm or less, and particularly preferably 0.6 m or less. The lower limit value of the particle diameter D₅₀ is not particularly limited, and the particle diameter D₅₀ is preferably 0.1 μm or more, and more preferably 0.3 μm or more, from the viewpoint of ease of handling.

In the sulfide solid electrolyte according to the present embodiment, in addition to the particle diameter D₅₀, the particle diameter distribution also contributes to ease of densification when formed into a battery. Specifically, the closer the value represented by {(D₁₀+D₉₀)/D₅₀} using D₁₀, D₅₀, and D₉₀ to 2.0 is, the narrower the particle diameter distribution is, which is preferable. Specifically, the value represented by the above expression is preferably 4.5 or less, more preferably 4.0 or less, and still more preferably 3.0 or less. The lower limit value of the value represented by the above expression is preferably as close as possible to 2.0, and the value represented by the above expression is substantially preferably 2.2 or more, and more preferably 2.5 or more.

Each surface anion content of the sulfide solid electrolyte can be determined by composition analysis (XPS analysis) using X-ray photoelectron spectroscopy. Specifically, a value obtained from the result of the XPS analysis of a region excavated to a depth of 50 nm from the outermost surface by sputtering is adopted.

As for S²⁻, it is considered that S forming an argyrodite crystal by covalently bonding with P in a state of PS₄³⁻and S as a surface anion are present. Therefore, the content of P is also measured simultaneously with the measurement of the content of S in the above analysis, and a value obtained by subtracting four times the content of detected P from the content of S detected in the same analysis is adopted as [S²⁻]₀. That is, [S²⁻]₀ is a value obtained by nornalizing the value obtained by {(content of S detected)−(content of P detected)×4}. In the case where the value obtained by the above expression is less than 0, that is, a negative value, [S²⁻]₀=0.

When a sum of the contents of the respective elements of S, O, Br, Cl, and F that are obtained by the XPS analysis is taken as 1, values obtained by normalizing the respective contents are [S²⁻]₀, [O²⁻]₀, [Br⁻]₀, [Cl⁻]₀, and [F⁻]₀, respectively. That is, [S²⁻]₀+[O²⁻]₀+[Br⁻]₀+[Cl⁻]₀+[F⁻]₀=1.

Among the above, the surface O²⁻content represented by [O²⁻]₀ is preferably 0.3 or more, more preferably 0.4 or more, and still more preferably 0.5 or more, from the viewpoint of reducing the surface anion parameter and further exhibiting the effect of the present invention. From the viewpoint of reducing the grain boundary resistance, [O²⁻]₀ is preferably 0.9 or less, more preferably 0.8 or less, and still more preferably 0.7 or less.

Among the above, the surface F⁻ content represented by [F⁻]₀ is preferably 0.01 or more, more preferably 0.02 or more, and still more preferably 0.04 or more, from the viewpoint of reducing the surface anion parameter and further exhibiting the effect of the present invention. From the viewpoint of reducing the grain boundary resistance, [F⁻]₀ is preferably 0.4 or less, more preferably 0.3 or less, and still more preferably 0.2 or less.

From the viewpoint of enhancing battery performance, [0²⁻]₀ is preferably larger than [S²⁻]₀, and a difference thereof is preferably 0.2 or more, more preferably 0.3 or more, and still more preferably 0.4 or more. The upper limit of the difference is not particularly limited, and the difference is generally 0.9 or less.

From the viewpoint of enhancing the battery performance, a proportion of [F⁻]₀ to a sum of [Br⁻]₀ and [Cl⁻]₀, that is, a ratio represented by {[F⁻]₀/([Br⁻]₀+[Cl⁻]₀)} is preferably 0.02 or more, more preferably 0.05 or more, and still more preferably 0.07 or more. From the viewpoint of the lithium ion conductivity, the ratio is preferably 0.3 or less, more preferably 0.2 or less, and still more preferably 0.1 or less.

As internal, that is, bulk properties of the sulfide solid electrolyte according to the present embodiment, the internal anion parameter is preferably 0.36 or less, more preferably 0.35 or less, and still more preferably 0.34 or less when a sum of [S²⁻]_{bulk}, [O²⁻]_{bulk}, [Br⁻]_{bulk}, [Cl⁻]_{bulk}, and [F⁻]_{bulk}, which are the internal anion contents, is taken as 1. From the viewpoint of forming an argyrodite crystal, a value of the internal anion parameter is preferably 0.30 or more, and more preferably 0.32 or more.

Among the internal anion contents, [S²⁻]_{bulk} is a value obtained by normalizing a value obtained by {(content of S detected)−(content of P detected)×4}, similar to [S²⁻]₀ among the surface anion contents. When the value obtained by the above expression is less than 0, that is, a negative value, [S²⁻]_{bulk}=0. The contents of S and P detected are contents obtained by composition analysis to be described later.

Each of [O²⁻]_{bulk}, [Br⁻]_{bulk}, [Cl⁻]_{bulk}, and [F⁻]_{bulk} is a value obtained by the following equation by taking the content of each element obtained by the composition analysis to be described later as the detected content.
[O²⁻]_{bulk}=(content of 0 detected)/normalizing value
[BC]_{bulk}=(content of Br detected)/normalizing value
[Cl⁻]_{bulk}=(content of Cl detected)/normalizing value
[F⁻]_{bulk}=(content of F detected)/normalizing value

The normalizing value is a value adjusted to satisfy [S²⁻]_{bulk}+[O²⁻]_{bulk}+[Br⁻]_{bulk}+[Cl⁻]_{bulk}+[F⁻]_{bulk}=1.

From the viewpoint of further exhibiting the effect of the present invention, [O²⁻]₀ is preferably larger than [O²⁻]_{bulk}, and a difference thereof is more preferably 0.2 or more, further preferably 0.3 or more, and particularly preferably 0.4 or more. From the viewpoint that extreme surface oxidation impairs the lithium ion conductivity, the difference thereof is preferably 0.9 or less, more preferably 0.7 or less, and still more preferably 0.6 or less.

From the viewpoint of enhancing the battery performance, the value of the surface anion parameter is preferably smaller than the value of the internal anion parameter, and a difference thereof is more preferably 0.01 or more, still more preferably 0.02 or more, and particularly preferably 0.03 or more. There is a limit to changing the composition only on the surface, and the difference thereof is preferably 0.05 or less.

As internal properties of the sulfide solid electrolyte according to the present embodiment, four or more kinds of anions are preferably present, and five or more kinds of anions are more preferably present, from the viewpoint of achieving both lithium ion conductivity and battery performance. Specifically, it is preferable to contain, as anions, one or two or more selected from F, O, I, Se, Te, and H in addition to at least one of Cl and Br and S.

Preferable examples of the combination in the case of containing four kinds of anions include a combination of S, Cl, Br, and O, a combination of S, Cl, Br, and F, a combination of S, Cl, F, and O, and a combination of S, Cl, I, and O.

Preferable examples of the combination in the case of containing five kinds of anions include a combination of S, Cl, Br, F, and O and a combination of S, Cl, Br, F, and I.

As internal, that is, bulk properties of the sulfide solid electrolyte according to the present embodiment, the argyrodite crystal preferably satisfies at least one of the following (A) and (B), from the viewpoint of preventing the degradation in battery characteristics during repeated charging and discharging.
(A) S, at least one of Cl and Br, and one or two or more elements different from S and at least one of Cl and Br are present in a free anion site, and
(B) a part of P in a 4b site and a part of S in a 16e site that is adjacent to P in the 4b site are respectively substituted with other elements.

For the free anion site in the above (A), in the case where the argyrodite crystal is a cubic crystal, a 4a site and a 4d site correspond to the free anion site. In the case where the argyrodite crystal is a rhombohedral crystal, a la site and a 3b site correspond to the free anion site.

A proportion of anions present in the free anion site, that is, free anions, can be more accurately determined by synchrotron X-ray diffraction (XRD) measurement. Specifically, a spectrum obtained by the synchrotron XRD measurement is subjected to structure refining analysis by a Rietveld method to determine an occupying element and an occupancy rate of each site. When a content of each element and a total thereof are determined by composition analysis using ICP emission spectrometry, atomic absorption, ion chromatography, or the like, and a crystal structure is refined by the Rietveld method based on the values, analysis can be performed with higher accuracy.

Examples of the one or two or more elements different from S, Cl and Br present in the free anion site include 0, F, Se, and I. From the viewpoint of high electronegativity and reducing the anion parameter, at least one of O and F is preferable, and F is more preferable.

For example, when O is present in the free anion site, 0 is substituted for S. When F is present in the free anion site, F is substituted for Cl or Br.

When such substitution is performed, the internal anion parameter becomes small, and as a result, the surface anion parameter also becomes small, and the deterioration in battery characteristics during repeated charging and discharging can be prevented without coating the surface of the positive electrode active material with LiNbO₃ or the like.

Another element M to be substituted for a part of P in the 4b site in the above (B) is preferably at least one element selected from the group consisting of metal elements and metalloid elements of Groups 2 to 14 of the periodic table, and more preferably an element forming an MS₄ tetrahedral structure having an ionic radius larger than that of PS₄³⁻.

Examples of the element M forming an MS₄ tetrahedral structure having a large ionic radius include Si, Sn, Al, V, Ti, Zr, Sb, and Ge. Among them, Si, Sn, V, Ge, and Zr are more preferable since they have a high valence and can be easily substituted for P.

Another element to be substituted for a part of S in the 16e site in the above (B) is preferably 0, and Se, and 0 is more preferable from the viewpoint of high electronegativity and reducing the internal anion parameter.

The other element M to be substituted for a part of P in the 4b site and the other element to be substituted for a part of S in the 16e site can be determined by the synchrotron XRD measurement and the Rietveld analysis, similar to those used for the proportion of free anions.

As described above, when the above (B) is satisfied, the effect of the present invention is exhibited even in the case where the value of the internal anion parameter is slightly high and the value of the surface anion parameter is accordingly slightly high. The deterioration in battery characteristics can be prevented even without a coating agent. When the above (B) is satisfied, the effect of the present invention is more easily exhibited even in the case where the value of the internal anion parameter is slightly high, as compared with the case where the above (A) is satisfied and the above (B) is not satisfied.

The above effect is more significant when the ionic radius of the MS₄ tetrahedral structure is larger than that of the PS₄³⁻structure. Therefore, as described above, the element M to be substituted for a part of P in the 4b site is preferably an element forming an MS₄ tetrahedral structure having an ionic radius larger than that of PS₄³, and the element M is more preferably at least one of Si and Sn. That is, the MS₄ tetrahedral structure is more preferably at least one of SiS₄⁴⁻and SnS₄⁴⁻, and in this case, it is preferable that a part of S is further substituted with O, Se, or the like, and the above (B) is satisfied.

When the ionic radius of the MS₄ tetrahedral structure is larger than that of the PS₄³⁻structure, an average bond distance between the 4b site and the 16e site adjacent thereto is preferably 2.07 Å or more, more preferably 2.08 Å or more, and still more preferably 2.10 Å or more. From the viewpoint of maintaining the crystal structure, the average bond distance is preferably 2.20 Å or less, more preferably 2.17 Å or less, and still more preferably 2.15 Å or less.

In the PS₄³⁻structure, the average bond distance between the 4b site and the 16e site adjacent thereto is 2.04 Å. The average bond distance can be determined by the synchrotron XRD measurement and the Rietveld analysis.

The argyrodite crystal structure may be analyzed from an XRD pattern using a general-purpose device, and is preferably analyzed from a synchrotron XRD pattern from the viewpoint of analysis precision.

An arrangement of each element in the crystal structure can be specified by refining the crystal structure using the Rietveld method on an XRD pattern measured using synchrotron X-rays.

Further, the content of each element and the total thereof can be determined by composition analysis using ICP emission spectrometry, atomic absorption, ion chromatography, or the like, and when the crystal structure is refined by the Rietveld method based on these values, a crystal composition can be determined with higher accuracy.

In the case where peaks are present at positions of 2θ=15.7±0.8° and 30.2±0.8° in the XRD pattern when a radiation source is Cu-Kα ray, it can be said that the crystal is a cubic argyrodite crystal. In addition to the above peaks, the XRD pattern preferably has a peak at a position of 2θ=18.0±0.8°, and further more preferably has a peak at a position of 2θ=25.7±0.8°.

In the case where peaks are present at positions of 2θ=15.8±0.8°, 25.8±0.8°, and 30.3±0.8° in the XRD pattern when a radiation source is Cu-Kα ray, and at least two of the three peaks are split into two or more peaks, it can be said that the crystal is a rhombohedral argyrodite crystal. In addition to the above, the XRD pattern preferably has a peak not split at a position of 2θ=18.1±0.8°, and further more preferably has a peak split at a position of 2θ=31.8±0.80.

For a ratio of contents (at %) of the elements constituting the argyrodite crystal, that is, a ratio of contents of the elements contained in the argyrodite crystal, when the composition is represented by Li_{α}PS_{β}Ha_{γ}, relationships of 5<α<7, 3<β<6, and 0<γ<2 are preferably satisfied, since the argyrodite crystal is likely to be formed. For such an element ratio, relationships of 5.1<α<6.3, 3.5<β<5.3, and 0.7<γ<1.9 are more preferably satisfied, and relationships of 5.2<α<6.2, 3.7<R<5.2, and 0.8<γ<1.8 are still more preferably satisfied.

That is, a is preferably more than 5, more preferably more than 5.1, and still more preferably more than 5.2, and is preferably less than 7, more preferably less than 6.3, and still more preferably less than 6.2.

β is preferably more than 3, more preferably more than 3.5, and still more preferably more than 3.7, and is preferably less than 6, more preferably less than 5.3, and still more preferably less than 5.2.

γ is preferably more than 0, more preferably more than 0.7, and still more preferably more than 0.8, and is preferably less than 2, more preferably less than 1.9, and still more preferably less than 1.8.

A preferable crystal structure of the argyrodite crystal is a cubic crystal such as F⁻43m, and may be the above-described rhombohedral crystal, or a hexagonal crystal, a tetragonal crystal, an orthorhombic crystal, a monoclinic crystal, or the like with reduced symmetry or a triclinic crystal with further reduced symmetry may exist.

The halogen element represented by Ha is at least one selected from the group consisting of F, Cl, Br, and I, and in view that the crystal is likely to be an argyrodite crystal, at least one of Cl and Br is contained, Cl is preferably contained, and elemental Cl or a mixture of Cl and Br is more preferably contained.

When Ha contains Cl and Br, a content ratio represented by (c1/c2) is preferably 0.1 or more, more preferably 0.3 or more, and still more preferably 0.5 or more, where c1 (at %) is the content of Cl in the argyrodite crystal and c2 (at %) is the content of Br. The (c1/c2) is preferably 10 or less, more preferably 3 or less, and still more preferably 1.6 or less. When the (c1/c2) satisfies the above range, an interaction between lithium ions and halide ions is weakened, and the lithium ion conductivity of the sulfide solid electrolyte is likely to be satisfactory. This is considered to be due to the influence of the mixed anion effect, which weakens the interaction between cations and anions by mixing bromide ions having an ionic radius larger than that of chloride ions. When the (c1/c2) satisfies the above range, the cycle characteristics of the lithium-ion secondary battery are likely to be improved.

For a ratio of contents (at %) of the elements constituting the argyrodite crystal in the case where Ha contains Cl and Br, when the composition is represented by Li_{α}PS_{β}Cl_{γ1}Br_{γ2}, γ1 is preferably 0.1 or more, more preferably 0.3 or more, and still more preferably 0.5 or more, and is preferably 1.5 or less, more preferably 1.4 or less, and still more preferably 1.3 or less. γ2 is preferably 0.1 or more, more preferably 0.3 or more, and still more preferably 0.5 or more, and is preferably 1.9 or less, more preferably 1.6 or less, and still more preferably 1.4 or less. When γ1 and γ2 each satisfy the above ranges, a stable argyrodite crystal can be obtained while an abundance proportion of halide ions in the crystal is optimized and the interaction between anions and lithium ions in the crystal is reduced. Accordingly, the lithium ion conductivity of the sulfide solid electrolyte is likely to be satisfactory. When γ1 and γ2 satisfy the above ranges, the cycle characteristics of the lithium-ion secondary battery are likely to be improved.

Here, α,β, and (γ1+γ2) preferably satisfy the same relationships as a, P, and γ described above, respectively.

The crystallite size of the crystals constituting a crystal phase is preferably small from the viewpoint of obtaining a good lithium ion conductivity when the sulfide solid electrolyte is used as a sulfide solid electrolyte layer to form a battery. Specifically, the crystallite size is preferably 1000 nm or less, more preferably 500 nm or less, and still more preferably 250 nm or less. The lower limit of the crystallite size is not particularly limited, and the crystallite size is generally 5 nm or more.

The crystallite size can be calculated by using a half-width of a peak of an XRD pattern and a Scherrer equation. A more precise value of the crystallite size can be determined by refining the crystal structure by using the Rietveld method.

The content of the argyrodite crystal with respect to the whole components constituting the sulfide solid electrolyte according to the present embodiment is preferably 50 mass % or more, more preferably 65 mass % or more, and still more preferably 80 mass % or more, from the viewpoint of implementing good battery characteristics. The upper limit of the content is not particularly limited, and the content may be 100 mass %. Alternatively, the content is generally 99 mass % or less.

The proportion of the argyrodite crystal can be calculated by adding an internal standard substance, measuring with XRD or neutral-beam scattering, and then comparing a peak intensity with that of the internal standard substance. The argyrodite crystal may include two or more crystal structures.

The content of the argyrodite crystal is a content including contents of an element other than S, Cl, and Br present in the free anion site and other elements substituted for P in the 4b site and S in the 16e site.

The content of each element and the total thereof are determined by composition analysis using ICP emission spectrometry, atomic absorption, ion chromatography, or the like. For oxygen, the total content of O contained in the sulfide solid electrolyte can be quantified by oxygen nitrogen hydrogen analysis. In the oxygen nitrogen hydrogen analysis, a measuring device can be selected according to the content of O. For example, in the case where the oxygen content is 0.05 ppm to 5.0% (weight proportion), ONH 836 manufactured by LECO Corporation is preferable, and in the case where the oxygen content is 5.0% or more, energy dispersive X-ray analysis or the like is preferable. The oxygen nitrogen hydrogen analysis may be combined with NMR analysis to quantify each difference in oxygen bonding state.

Other than the argyrodite crystal, an amorphous component capable of serving argyrodite, an oxide anion, and an impurity crystal phase such as Li₃PS₄, Li₄P₂S₆, Li₂S, and LiHa (where Ha is at least one halogen element selected from F, Cl, Br, and I) may be contained in the solid electrolyte.

When the sulfide solid electrolyte according to the present embodiment is formed into a pressure-molded body at a pressure of 380 MPa, the lithium ion conductivity of the sulfide solid electrolyte at 25° C. is preferably 3 mS/cm or more, more preferably 4 mS/cm or more, and still more preferably 5 mS/cm or more, and the higher the lithium ion conductivity, the better. The lithium ion conductivity can be determined from a Nyquist plot obtained by AC impedance measurement.

### (Lithium-ion Secondary Battery)

In the case where the sulfide solid electrolyte according to the present embodiment is used for a lithium-ion secondary battery, a good SEI is formed without performing surface coating on the positive electrode active material, and thus the deterioration in battery characteristics during repeated charging and discharging can be prevented.

In the charge and discharge test, an initial characteristic represented by (discharge capacity at first cycle/charge capacity at first cycle) is preferably more than 0.70, more preferably 0.75 or more, and still more preferably 0.80 or more, and the higher the initial characteristic, the better. When an initial characteristic of a sulfide solid electrolyte that has a bulk composition same as that of the sulfide solid electrolyte according to the present embodiment, in which an internal anion parameter of the sulfide solid electrolyte and a surface anion parameter thereof show similar values, and the surface anion parameter is more than 0.33 is taken as 1, the initial characteristic of the sulfide solid electrolyte according to the present embodiment is preferably more than 1.0, and more preferably 1.1 or more.

In the charge and discharge test, a capacity retention ratio represented by (discharge capacity at fifth cycle/discharge capacity at first cycle)×100(%) is preferably more than 90%, more preferably 92% or more, and still more preferably 94% or more, and the higher the capacity retention ratio, the better. When a capacity retention ratio of the sulfide solid electrolyte that has a bulk composition same as that of the sulfide solid electrolyte according to the present embodiment, in which an internal anion parameter of the sulfide solid electrolyte and a surface anion parameter thereof show similar values, and the surface anion parameter is more than 0.33 is taken as 1, the capacity retention ratio of the sulfide solid electrolyte according to the present embodiment is preferably more than 1.0, and more preferably 1.05 or more.

In the case where the sulfide solid electrolyte is used for a lithium-ion secondary battery, the sulfide solid electrolyte may form a solid electrolyte layer together with other components such as a binder as necessary. As the binder or other components, known substances according to the related art can be used.

The content of the sulfide solid electrolyte with respect to the entire solid electrolyte layer is preferably 80 mass % or more, and more preferably 90 mass % or more.

As a method for forming the solid electrolyte layer, a known method according to the related art can also be used. As an example of wet forming, the solid electrolyte layer can be formed by dispersing or dissolving the components constituting the solid electrolyte layer in a solvent to form a slurry, applying the slurry in the form of a layer, that is, a sheet, drying the slurry, and arbitrary pressing the sheet. If necessary, the binder may be removed by heating. A thickness of the solid electrolyte layer can be easily adjusted by adjusting a coating amount of the slurry or the like.

In addition, instead of wet forming, the solid electrolyte layer may be formed by press-forming the sulfide solid electrolyte powder or the like on a surface of a positive electrode, a negative electrode, or the like by a dry method. Alternatively, the solid electrolyte layer may be formed on another base material and transferred onto a surface of a positive electrode, a negative electrode, or the like.

The sulfide solid electrolyte may be mixed with a positive electrode active material or a negative electrode active material to be used as a positive electrode layer or a negative electrode layer. As the positive electrode active material or negative electrode active material used for the positive electrode layer or negative electrode layer, a current collector, a binder, a conductive aid, and the like, known materials according to the related art can be used.

Among them, as for the positive electrode active material, it is preferable to use LiCoO₂, NMC, and the like, which are surface-coated with LiNbO₃ according to the related art, or the like, since the effect exhibited by the present invention can be further obtained.

A positive electrode active material that operates at a higher potential than in the related art, for which surface coating with LiNbO₃ or the like is difficult to apply, is also preferable, since the effect of the present invention can be further obtained. Specifically, a positive electrode active material generally called 5V class, such as a spinel crystal LiNiₓMn₂₋ₓO₄, which is known as a high potential positive electrode active material, is preferable. As an index of the positive electrode active material that operates at a higher potential than in the related art, the sulfide solid electrolyte is preferably used for a lithium-ion secondary battery having an electromotive force of 4.3 V or more.

A lithium-ion secondary battery for which the sulfide solid electrolyte is used includes the solid electrolyte layer, the positive electrode layer, and the negative electrode layer. As the material of an outer casing of the lithium-ion secondary battery, known materials according to the related art may also be used. As the shape of the lithium-ion secondary battery, known shapes according to the related art may be used, and examples of the shape of the lithium-ion secondary battery include a coin shape, a sheet shape (film shape), a folded shape, a wound cylindrical shape with a bottom, and a button shape. The shape thereof can be appropriately selected according to the application.

### <Method for Manufacturing Sulfide Solid Electrolyte>

A method for manufacturing the sulfide solid electrolyte to be used for a lithium-ion secondary battery according to the present embodiment is not particularly limited as long as the argyrodite crystal can be precipitated and the surface anion parameter thereof becomes small.

Specifically, it is preferable that a homogeneous intermediate compound is formed before precipitating an argyrodite crystal. The homogeneous intermediate compound is not simply a mixture of a plurality of raw materials, but one in which the raw materials react with each other and a structure becomes, for example, amorphous or melted into a molten solution. When the surface anion parameter of the sulfide solid electrolyte thus obtained is still large, it is preferable to perform a post-treatment to lower the surface anion parameter.

In order to obtain a homogeneous amorphous intermediate compound, for example, there is a method in which raw materials are mixed by a medium-less pulverizer such as a mixer mill or a pin mill, and then mechanically mixed by a medium pulverizer such as a planetary ball mill, a bead mill, or an Ato Writer (registered trademark) to cause a mechanochemical reaction. The raw materials may be mixed in a mixer mill or a pin mill and then dissolved, and the mixture in a dissolved state can be called as the homogeneous intermediate compound. The raw materials in a state of being once dissolved in an organic solvent or the like may be used.

The method of the post-treatment is not particularly limited as long as the surface anion parameter becomes small, and for example, a method of performing a heat treatment under an atmosphere containing oxygen, a gas treatment such as an ozone treatment, a UV treatment, a plasma treatment, and the like are considered. As a method of reducing the surface anion parameter, it is also preferable to reduce the particle diameter D₅₀ of the sulfide solid electrolyte before performing the post-treatment.

The method for manufacturing the sulfide solid electrolyte according to the present embodiment is not particularly limited as long as the surface anion parameter of the sulfide solid electrolyte becomes small as described above. Examples thereof include the following two manufacturing methods: a manufacturing method i and a manufacturing method ii.

### (Manufacturing Method i)

The manufacturing method i includes:
a step i-1: mixing raw materials containing Li, P, S and Ha to obtain a raw material mixture,
a step i-2: heating the raw material mixture to obtain a molten material as an intermediate compound,
a step i-3: cooling the molten material to precipitate an argyrodite crystal, and
a step i-4: subjecting the above crystal to a heat treatment.

### (Manufacturing Method ii)

The manufacturing method ii includes:
a step ii-1: mixing raw materials containing Li, P, S and Ha to obtain an amorphous intermediate compound,
a step ii-2: heating and sintering the intermediate compound to precipitate an argyrodite crystal, and
a step ii-3: subjecting the above crystal to a heat treatment.

The intermediate compound obtained in the above step ii-1 is an amorphous intermediate compound in which no peaks derived from the above raw materials are observed in powder XRD measurement.

First, the manufacturing method i will be described.

The step i-1 is a step of mixing raw materials containing Li, P, S and Ha to obtain a raw material mixture.

As the raw materials, known materials according to the related art can be used as materials for obtaining an argyrodite crystal containing Li, P, S, and Ha. Examples thereof include a mixture of a compound containing Li (lithium), a compound containing P (phosphorus), a compound containing S (sulfur), and a compound containing Ha (halogen).

A raw material, which is a source of an element other than S, Cl, and Br present in an anion site, or a raw material, which is a source of other elements, in the case where the other elements are contained, is also mixed.

Examples of the compound containing Li include lithium compounds such as lithium sulfide (Li₂S), lithium oxide (Li₂O), lithium carbonate (Li₂CO₃), lithium hydroxide (LiOH), and lithium sulfate (Li₂SO₄), and elemental lithium metal.

Examples of a compound containing P include phosphorus sulfides such as phosphorus trisulfide (P₂S³) and phosphorus pentasulfide (P₂S₅), phosphorus compounds such as lithium phosphate (LiPO₃, Li₄P₂O₇, and Li₃PO₄) and sodium phosphate (NaPO₃, Na₄P₂O₇, and Na₃PO₄), and elemental phosphorus.

Examples of the compound containing S include lithium sulfide (Li₂S), phosphorus sulfides (P₂S₃ and P₂S⁵), and hydrogen sulfide (H₂S), and elemental sulfur may also be used. Among the compound containing Ha, examples of a compound containing Cl (chlorine) include lithium chloride (LiCl), phosphorus trichloride (PCl₃), phosphorus pentachloride (PCI₅), diphosphorus tetrachloride (P₂Cl₄), phosphoryl chloride (POCl₃), sulfur dichloride (SCl2), disulfur dichloride (S₂Cl₂), sodium chloride (NaCl), and boron trichloride (BCl₃).

Among the compound containing Ha, examples of a compound containing Br (bromine) include lithium bromide (LiBr), phosphorus tribromide (PBr₃), phosphoryl bromide (POBr3), disulfur dibromide (S₂Br₂), sodium bromide (NaBr), and boron tribromide (BBr3). Among them, a combination of lithium sulfide, phosphorus sulfides, and at least one of lithium chloride and lithium bromide is preferable.

Examples of the raw material, which is a source of an element other than S, Cl, and Br present in the anion site, or other elements, include silicon oxide (SiO₂), tin oxide (SnO), fluorides such as lithium fluoride (LiF), sulfides such as silicon disulfide (SiS₂), tin disulfide (SnS₂), germanium disulfide (GeS₂), vanadium (III) sulfide (V₂S₃), and zirconium disulfide (ZrS₂), selenium (Se), alkali metal oxides such as lithium oxide (Li₂O), lithium hydroxide (LiOH), and sodium oxide (Na₂O), alkali metal hydroxides, and alkali metal earth oxides.

Some of these raw materials to be used may be very unstable in the air, may react with water and decomposed, and may generate hydrogen sulfide gas or be oxidized. In this case, the raw materials are preferably mixed in an inert atmosphere. In the case where raw materials unstable in the air are not used, mixing may be performed in the air.

The raw materials can be mixed by, for example, medium-less mixing such as a mixer mill, a pin mill, a powder stirrer, and air flow mixing. A part of the raw materials may be made amorphous by mixing before the step i-2.

The step i-2 is a step of heating the obtained raw material mixture to obtain a molten material as an intermediate compound.

A molten state means that no peaks derived from the raw materials are observed in high-temperature X-ray diffraction measurement. In the case where the argyrodite crystal has, for example, a Li—P—S-Ha composition, the molten solution mixes well. Therefore, it means that the molten solution is a homogeneous compound molten material that is different from the raw materials. As a simple method to confirm whether the material is in a molten state, it can be to confirmed by observing the state of the raw materials in a furnace. No un-melted material observed means a complete dissolution and it can be said to be an intermediate compound.

By forming the intermediate compound, it becomes easier to substitute an element other than S, Cl, and Br in the anion site, or to substitute other elements in place of P and S.

The high-temperature X-ray diffraction measurement is performed after setting the measurement temperature, holding time, atmosphere, and the like such that they are the same as heating conditions used to obtain the molten material.

By performing the high-temperature X-ray diffraction measurement while changing the measurement temperature, changes in crystal state such as phase transition can be followed and the heating temperature at which an intermediate compound can be obtained can be estimated.

The heating conditions for obtaining the molten material vary depending on the raw materials to be used and the composition of the raw material mixture.

The heating temperature may be equal to or higher than a heating temperature at which the homogeneous amorphous intermediate compound as described above can be obtained. For example, the heating temperature is preferably 550° C. or higher, more preferably 600° C. or higher, and still more preferably 650° C. or higher. The heating temperature is preferably 950° C. or lower, more preferably 900° C. or lower, and still more preferably 850° C. or lower, from the viewpoint of preventing composition deviation due to volatilization of the components. The heating temperature may be changed stepwise in the above temperature range. The higher the halogen content represented by [Ha]/[P](atomic ratio) in the composition, the lower the heating temperature can be set.

The heating time may be equal to or longer than a time at which the homogeneous amorphous intermediate compound as described above can be obtained, and may vary also depending on the scale. For example, the heating time is preferably 2 minutes or longer, more preferably 5 minutes or longer, and still more preferably 10 minutes or longer. The heating time is preferably 360 minutes or shorter, more preferably 180 minutes or shorter, and still more preferably 120 minutes or shorter, from the viewpoint of productivity.

By stirring during heating and melting, a molten material to be an amorphous intermediate compound can be made more homogeneous. The more homogeneous the mixing in the step i-1, the shorter the heating time in the subsequent step i-2 can be set.

A specific method during heating and melting is not particularly limited, and examples thereof include a method in which raw materials are charged into a heat-resistant container and heated in a heating furnace. The heat-resistant container is not particularly limited, and examples thereof include a heat-resistant container made of carbon, a heat-resistant container containing an oxide such as quartz, a quartz glass, a borosilicate glass, an aluminosilicate glass, alumina, zirconia, and mullite, a heat-resistant container containing a nitride such as silicon nitride and boron nitride, and a heat-resistant container containing a carbide such as silicon carbide. These heat-resistant containers may be a container in which a bulk is formed of the above-described material, or a layer of carbon, an oxide, a nitride, a carbide, or the like is formed.

The raw materials are preferably mixed in an inert atmosphere, and the molten material is also preferably obtained by heating in the inert atmosphere as it is. Examples of the inert atmosphere include an Ar atmosphere and a nitrogen atmosphere, and a nitrogen atmosphere is more preferable from the viewpoint of production cost. The molten material may be obtained by heating in a hydrogen sulfide gas atmosphere, a sulfur gas atmosphere, a sulfur dioxide gas atmosphere, or a mixed gas atmosphere of these gases. The raw materials may be heated in a vacuum-sealed state.

When Ha in the argyrodite crystal phase contains Br, Br is less likely to enter the crystal structure since Br has an ionic radius larger than that of Cl. Therefore, a homogeneous intermediate compound can be easily obtained when the heating conditions for obtaining the molten material is adjusted by making the heating temperature higher than the above-described range, making the heating time longer, or performing both.

However, in the manufacturing method i in which the intermediate compound is a molten material, the intermediate compound is likely to be homogeneous because of a high fluidity thereof. Therefore, since Br having a large ionic radius is also likely to enter the crystal structure, the above-described adjustment is not necessarily required.

The amorphous intermediate compound may suffice as long as no peaks derived from the raw materials are observed in the high-temperature X-ray diffraction measurement, and from the viewpoint of homogeneity, the amorphous intermediate compound is preferably a homogeneous molten solution with no phase separation. In the case where the argyrodite crystal has a Li—P—S-Ha composition, the molten solution mixes well without phase separation, and the presence or absence of phase separation can be confirmed visually. The presence or absence of phase separation may be confirmed based on whether light is optically transmitted without being scattered.

The step i-3 is a step of cooling the molten material, which is an amorphous intermediate compound, to precipitate an argyrodite crystal. As long as the lithium ion conductivity and elastic modulus of the solid electrolyte are not affected, impurities derived from the raw materials or the like may be contained in the argyrodite crystal.

Cooling conditions for precipitating crystals vary depending on the composition and target crystallization rate.

The cooling rate is not particularly limited as long as an argyrodite crystal can be precipitated, and from the viewpoint of productivity, the cooling rate is preferably 5° C./min or more, more preferably 10° C./min or more, and still more preferably 30° C./min or more. From the viewpoint of increasing the crystallization rate, the cooling rate is preferably 2000° C./min or less, more preferably 1000° C./min or less, and still more preferably 300° C./min or less.

It is more preferable to extend a residence time at 200° C. to 450° C. during cooling and perform crystal growth or reconstruction of the crystal structure from the viewpoint of improving the lithium ion conductivity. After cooling to room temperature once, a heat treatment may be additionally performed at a temperature of 200° C. to 550° C.

The atmosphere during cooling is preferably an inert atmosphere, similar to that for the mixing of raw materials and heating for obtaining the molten material. In the case where the heating for obtaining the molten material is performed under a vacuum-sealed state, the cooling may also be performed under the vacuum-sealed state as it is.

The step i-4 is a step of subjecting the crystal obtained in the step i-3 to a heat treatment.

When the heat treatment is performed under a special atmosphere, the surface anion parameter tends to be small, and when the heat treatment is further performed under an atmosphere containing oxygen, the surface anion parameter becomes smaller. This is considered to be due to an oxidative decomposition treatment of adsorbed substances on the surface of the sulfide solid electrolyte.

The oxygen concentration in the heat treatment is preferably 5 ppm or more, more preferably 10 ppm or more, and still more preferably 50 ppm or more in terms of volume ratio, from the viewpoint of promoting surface oxidation. From the viewpoint of preventing oxidative decomposition, the oxygen concentration is preferably 5 vol % or less, more preferably 1 vol % or less, and still more preferably 0.1 vol % or less.

The dew point in the heat treatment is preferably −65° C. or higher, more preferably −60° C. or higher, and still more preferably −55° C. or higher, from the viewpoint of promoting the surface oxidation. From the viewpoint of maintaining the lithium ion conductivity, the dew point is preferably −30° C. or lower, more preferably −35° C. or lower, and still more preferably −40° C. or lower.

The heating temperature in the heat treatment is preferably 150° C. or higher, more preferably 200° C. or higher, and still more preferably 250° C. or higher, from the viewpoint of promoting surface reaction. From the viewpoint of preventing aggregation, the heating temperature is preferably 400° C. or lower, more preferably 350° C. or lower, and still more preferably 300° C. or lower.

The heating time in the heat treatment is preferably 1 minute or longer, more preferably 10 minutes or longer, and still more preferably 60 minutes or longer, from the viewpoint of sufficiently advancing the surface reaction. From the viewpoint of productivity, the heating time is preferably 300 minutes or shorter, more preferably 180 minutes or shorter, and still more preferably 120 minutes or shorter.

The heat treatment may be a one-stage heat treatment performed under one condition, or may be a two-stage or more heat treatment performed under two or more conditions. In the case of performing the two-stage or more heat treatment, the respective conditions preferably satisfy the above-described ranges of the oxygen concentration, dew point, and heating temperature, and the total heating time of all the conditions preferably satisfies the above-described range of the heating time.

In the case of performing the two-stage heat treatment, it is preferable that the dew points are the same in a first stage and a second stage, or the dew point is lower in the second stage, from the viewpoint of maintaining the lithium ion conductivity. The oxygen concentration is preferably lower in the second stage than in the first stage, from the viewpoint of maintaining the lithium ion conductivity. The heating temperature is preferably higher in the second stage than in the first stage, from the viewpoint of promoting the surface modification reaction.

Along with the step i-4 or in place of the step i-4, a method of reducing the surface anion parameter by a gas treatment such as an ozone treatment, a UV treatment, a plasma treatment, or the like is also considered. The ozone treatment is a treatment of applying oxygen to the surface of the solid electrolyte, and the UV treatment and the plasma treatment are treatments of removing adsorbed substances on the surface of the solid electrolyte. Therefore, it is considered that these treatments also reduce the surface anion parameter. The surface anion parameter can also be reduced by reducing the particle diameter D₅₀ of the crystal obtained in the step i-3 before the step i-4.

As described above, by adopting the manufacturing method i according to the present embodiment, a sulfide solid electrolyte having a small surface anion parameter can be obtained. As a result, even when the surface of the positive electrode active material is not treated with a coating agent, the deterioration in battery characteristics during repeated charging and discharging can be prevented.

A preferable aspect of the obtained solid electrolyte is the same as the preferable aspect described in the above <Sulfide Solid Electrolyte>.

Next, the manufacturing method ii will be described.

The step ii-1 is a step of mixing raw materials to obtain a homogeneous amorphous intermediate compound.

In order to obtain an argyrodite crystal, raw materials containing Li, P, S, and Ha are used, and the raw materials can be the same as those described in the step i-1 of the manufacturing method i and can be used under the same conditions.

A raw material, which is a source of an element other than S, Cl, and Br present in the anion site and other elements, is also mixed, and the raw material can also be the same as those described in the step i-1 of the manufacturing method i and can be used under the same conditions.

An amorphous intermediate compound can be obtained by adopting conditions that are much stricter than in the related art in mixing these raw materials.

An amorphous (non-crystalline) intermediate compound means that no peaks derived from the raw materials are observed in the X-ray diffraction measurement, and this means that the amorphous intermediate compound is a homogeneous compound that is different from a mixture of the raw materials.

By forming the amorphous intermediate compound, the surface anion parameter can be easily reduced. Specifically, by making it easier to substitute an element other than S, Cl, and Br in the anion site, or to substitute other elements in place of P and S, the internal (=bulk) anion parameter is likely to be small, and further by modifying the surface, it is easier to lower the surface anion parameter.

In the case of, for example, using a mechanical milling method using a ball mill to mix the raw materials, examples thereof include a rotary ball mill that provides rotation movement to a container, a vibrating ball mill that provides vibrational movement, a planetary ball mill that provides revolution and rotational movement, a bead mill, and Attritor (registered trademark), and any of these methods can be adopted as long as the conditions are employed such that an amorphous intermediate compound can be obtained. Among them, a planetary ball mill or a bead mill having a higher mixing force or pulverizing force is preferable.

In the case of the mechanical milling method using a ball mill, the higher the rotation speed, the longer the mixing time, and the smaller the particle diameter of the ball, the higher the mixing force and pulverizing force.

The rotation speed varies depending on the type of ball mill to be used or other conditions, and is preferably 200 rpm or more, more preferably 300 rpm or more, and still more preferably 400 rpm or more. The upper limit of the rotation speed is not particularly limited, and the rotation speed is preferably 1000 rpm or less, and more preferably 800 rpm or less, from the viewpoint of mechanical strength.

A plurality of rotation speeds may be combined, such as initially mixing at a low rotation speed for a certain period of time, then increasing the rotation speed to a high rotation speed and mixing for a certain period of time.

The mixing time varies depending on the type of ball mill to be used or other conditions, and is preferably 0.5 hours or longer, more preferably 2 hours or longer, and still more preferably 4 hours or longer. The upper limit of the mixing time is not particularly limited, and the mixing time is preferably 50 hours or shorter, and more preferably 20 hours or shorter, from the viewpoint of productivity.

The particle diameter of the ball varies depending on the type of ball mill to be used or other conditions, and is preferably 20 mm or less, more preferably 10 mm or less, and still more preferably 5 mm or less. The lower limit of the particle diameter of the ball is preferably 0.3 mm or more, and more preferably 1 mm or more, from the viewpoint of ease of handling. Two or more kinds of balls having different particle diameters may be used in combination.

The amount of balls to be used varies depending on the type of ball mill to be used or other conditions. From the viewpoint of mixing force and pulverizing force, the weight of the balls to be used is preferably 20% or more, more preferably 50% or more, and still more preferably 100% or more, and is preferably 1000% or less, more preferably 500% or less, and still more preferably 400% or less, with respect to a total weight of the raw materials.

The ball mill may be dry mixing or wet mixing using a dispersion medium, and dry mixing is preferable from the viewpoint of efficiently transmitting energy.

By the mixing as described above, not only the raw materials are mixed, but also the mixed powder is made amorphous, and a homogeneous amorphous intermediate compound can be obtained.

As described above, the obtained amorphous intermediate compound means that no XRD peaks derived from the raw materials are observed, and it may be considered that a more homogeneous intermediate is obtained when it can be confirmed in the Raman spectrum that peaks at positions of the raw materials completely disappear and a peak appears at another position.

In the powder X-ray diffraction measurement used for verifying the obtained amorphous intermediate compound, when the particle diameter of the sample powder is very small, no peak may be observed even in the case where the sample powder is crystalline. Therefore, from the viewpoint of distinguishing a mixture of raw materials having a very small particle diameter from an amorphous intermediate compound, the particle diameter of the intermediate compound is preferably 100 nm or more. On the other hand, the particle diameter of the intermediate compound is preferably 20 m or less, more preferably 10 μm or less, and still more preferably 5 m or less, from the viewpoint of reducing the primary particle diameter of the powder with the progress of mixing.

The particle diameter of the intermediate compound in the present description is a primary particle diameter determined from an image obtained by scanning electron microscopic (SEM) observation. The primary particle diameter is determined by performing SEM measurement without exposure to the air, observing at a magnification of 2000 times and an accelerating voltage of 2 kV, measuring the particle diameters of 20 particles reflected within an appropriate field of view, and determining an average value thereof as the primary particle diameter.

The step ii-2 is a step of heating and sintering the amorphous intermediate compound obtained in the step ii-1 to precipitate an argyrodite crystal. As described above, as long as the lithium ion conductivity and elastic modulus of the solid electrolyte are not affected, impurities derived from the raw materials or the like may be contained in the argyrodite crystal.

The heating is preferably performed, for example, under an inert gas atmosphere, under a hydrogen sulfide gas atmosphere, under a sulfur gas atmosphere, or under a vacuum-sealed state.

The heating temperature is preferably 350° C. or higher, more preferably 400° C. or higher, and still more preferably 450° C. or higher, from the viewpoint of promoting the solid-phase reaction, that is, crystallization. From the viewpoint of preventing thermal decomposition, the heating temperature is preferably lower than 600° C., and more preferably 575° C. or lower.

From the same viewpoint, the heating time is preferably 1 hour or longer, more preferably 2 hours or longer, and still more preferably 4 hours or longer. The heating time is preferably 100 hours or shorter, more preferably 50 hours or shorter, and still more preferably 24 hours or shorter.

The step ii-3 is a step of subjecting the crystal obtained in the step ii-2 to a heat treatment.

As a specific heat treatment method, the same method as described in the step i-4 of the manufacturing method i can be applied under the same conditions.

As described above, by adopting the manufacturing method ii according to the present embodiment, a sulfide solid electrolyte having a small surface anion parameter can be obtained. As a result, even when the surface of the positive electrode active material is not treated with a coating agent, the deterioration in battery characteristics during repeated charging and discharging can be prevented.

A preferable aspect of the obtained solid electrolyte is the same as the preferable aspect described in the above <Sulfide Solid Electrolyte>.

### EXAMPLES

Hereinafter, the present invention will be described in detail with reference to Examples, but the present invention is not limited thereto.

Example 1 to Example 4 are Inventive Examples, and Example 5 is Comparative Example. [0123](Example 1) Under a dry nitrogen atmosphere, 7.5 g of lithium sulfide powder (manufactured by Sigma Corporation, purity: 99.98%), 11.1 g of phosphorus pentasulfide powder (manufactured by Sigma Corporation, purity: 99%), 3.3 g of lithium chloride powder (manufactured by Sigma Corporation, purity: 99.99%), 6.8 g of lithium bromide powder (manufactured by Sigma Corporation, purity: 99.995%), 0.9 g of lithium oxide powder (manufactured by Sigma Corporation, purity: 97%), and 0.3 g of lithium fluoride powder (manufactured by Sigma Corporation, purity: 99.98%) were weighed. At this time, a ratio represented by Li:P:S:O:Br:Cl is 5.30:0.95:3.93:0.30:0.75:0.75:0.10 in atomic ratio. In the same atmosphere, mixing was performed for 1 minute in a High mode by using a mixer (X-TREME (MX 1100 XTM) manufactured by WARING), to obtain a raw material mixture. The obtained raw material mixture was charged into a heat-resistant container, heated at 300° C. for 1 hour in an atmosphere having a dew point of −60° C., and then the temperature was raised, followed by heating at 700° C. for 0.5 hours to obtain a molten material. The molten material was cooled to room temperature at a rate of 300° C./min to precipitate an argyrodite crystal. Thereafter, the argyrodite crystal was pulverized in a mortar and passed through a sieve having an opening of 43 μm to obtain a powder having a particle diameter D₅₀ of 5 km. Next, a heat treatment was performed at 200° C. for 60 minutes under an atmosphere having an oxygen concentration of 100 ppm and a dew point of −50° C., and further a heat treatment was performed at 350° C. for 60 minutes under an atmosphere having an oxygen concentration of 10 ppm and a dew point of −55° C., thereby obtaining a sulfide solid electrolyte containing an argyrodite crystal.

As a result of an XRD measurement (Smart Lab, manufactured by Rigaku Corporation) of the obtained argyrodite crystal under the following conditions, it was confirmed from the obtained diffraction pattern that the argyrodite crystal was a cubic crystal. (Conditions) The conditions of the XRD measurement are as follows.

Radiation Source: CuKα ray (λ=1.5418 Å), tube bulb voltage: 45 kV, tube bulb current: 200 mA, scanning angle: 10° to 100°, scanning speed: 5°/min, number of steps: 0.01°/step.

### Example 2

A sulfide solid electrolyte containing an argyrodite crystal was obtained in the same manner as in Example 1 except that heat treatments after an argyrodite crystal was precipitated and a powder was obtained was changed such that a heat treatment was performed at 200° C. for 60 minutes under an atmosphere having an oxygen concentration of 1000 ppm and a dew point of −50° C., and further a heat treatment was performed at 350° C. for 60 minutes under an atmosphere having an oxygen concentration of 100 ppm and a dew point of −50° C.

### Example 3

After preparing and mixing the same amount of raw materials as in Example 1, 10 mass % based thereto of SiO₂ powder (manufactured by As One Corporation, used by crushing quartz test tube SJT series) was added and then, additionally mixed. A sulfide solid electrolyte containing an argyrodite crystal was obtained in the same manner as in Example 1 except that a heat treatment after an argyrodite crystal was precipitated and a powder was obtained was changed to a one-stage treatment at 350° C. for 60 minutes under an atmosphere having an oxygen concentration of 10 ppm and a dew point of −60° C.

### Example 4

Under a dry nitrogen atmosphere, 7.5 g of lithium sulfide powder (manufactured by Sigma Corporation, purity 99.98%), 11.1 g of phosphorus pentasulfide powder (manufactured by Sigma Corporation, purity 99%), 3.6 g of lithium chloride powder (manufactured by Sigma Corporation, purity 99.99%), 7.3 g of lithium bromide powder (manufactured by Sigma Corporation, purity 99.995%), and 0.9 g of lithium oxide powder (manufactured by Sigma Corporation, purity 97%) were weighed. At this time, a ratio represented by Li:P:S:O:Br:Cl is 5.30:0.95:3.93:0.30:0.80:0.80 in atomic ratio. In the same atmosphere, mixing was performed for 1 minute in a High mode by using a mixer (X-TREME (MX 1100 XTM) manufactured by WARING), to obtain a raw material mixture. An argyrodite crystal was precipitated in the same manner as in Example 1 until melting and cooling.

Next, 2 g of the obtained sulfide solid electrolyte was charged with 8 g of a mixed solvent of heptane (CAS No. 142-82-5) having a moisture concentration of 10 ppm and dibutyl ether (CAS No. 142-96-1) in a 45 ml-size zirconia sealed pot, and a zirconia ball was charged therein, followed by wet pulverization in a planetary ball mill (LP-M2, manufactured by Ito Seisakusho Co., Ltd.) under the conditions of 200 rpm×120 min to obtain a powder. Thereafter, heat drying was performed for 2 hours in a heating space having a dew point of −65° C. and a temperature of 180° C. to obtain a powder. The particle diameter of the obtained powder was 0.2 μm for D₁₀, 0.5 μm for D₅₀, and 1.3 μm for D₉0.

Next, a heat treatment was performed at 300° C. for 5 minutes under an atmosphere having an oxygen concentration of 10 ppm and a dew point of −55° C. to obtain a sulfide solid electrolyte containing an argyrodite crystal. It was confirmed that there was no change in the particle diameter before and after the heat treatment.

### Example 5

Raw materials were prepared in the same manner as in Example 4. A sulfide solid electrolyte containing an argyrodite crystal was obtained in the same manner as in Example 1 except that the dissolution step and the subsequent steps were performed in the same manner as in Example 1 but the heat treatment was not performed after the argyrodite crystal was precipitated.

### Evaluation

### (Surface Anion Parameter)

The sulfide solid electrolyte was subjected to XPS analysis by wide scan analysis using a photoelectron spectrometer (ESCA 5500, manufactured by ULVAC-PHI) by using a transfer vessel. Conditions were as follows.

Pass energy: 93.9 eV, step energy: 0.8 eV, analysis area: 800 μm in diameter, detection angle: 45° with respect to sample surface, X-ray source: A1 ray, monochrome 14 kV, 300 W, sputtering type: C60 ion, and sputtering rate: 0.74 nm/min (in terms of thermal oxide film SiO₂)

For the baseline, measurement was performed by using Li₂S (manufactured by Sigma Corporation, purity 99.98%) in the same procedure as above, and the O1s value at a position of 50 nm in sputtering depth in terms of SiO₂ film was taken as the zero point of oxygen atom.

The composition at a position of 50 nm in sputtering depth in terms of SiO₂ film was analyzed as the surface composition.

The contents of S, O, Br, Cl, and F that were obtained as a result of the analysis were normalized such that a sum thereof was 1, and were defined as [S²⁻]₀, [O²⁻]₀, [Br⁻]₀, [Cl⁻]₀, [F⁻]₀, respectively. Since S contains S constituting an argyrodite crystal by covalent bonding with P in a state of PS₄³⁻and S as a surface anion, a value obtained by {(content of S detected)−(content of P detected)×4} was normalized as the content of S. In the case where the value obtained by the above expression is less than 0, that is, a negative value, [S²⁻]₀=0.

The normalized content of each anion was shown in each item of “Anion content” in “Surface composition” in Table 1. The value of the surface anion parameter calculated by the following expression by using the normalized content of each anion and the electronegativity was shown in “Surface anion parameter” in “Surface composition” in Table 1. The electronegativity of each element in the anion parameter is χ_{(S)}=2.5, χ_{(O)}=3.5, χ_{(Br)=}2.8, χ_{(Cl) =}3.0, and χ_{(F)=}4.0.

{(1/χ₍ₛ₎)×[S²⁻]₀+(1/χ_{(O)})×[O²⁻]₀+(1/χ_{(Br)})×[Br⁻]₀+(1/χ_{(Cl)})×[Cl⁻]₀+(1/χ_{(F)})×[F⁻]₀}

### (Internal Anion Parameter)

The value of the internal anion parameter calculated by the following expression by using the value described in “Anion content” in “bulk composition” in Table 1 and the electronegativity was shown in the item of “Internal anion parameter” in “Bulk composition” in Table 1. The electronegativity of each element in the anion parameter is χ_{(S)}=2.5, χ_{(O)}=3.5, χ_{(Br)=}2.8, χ_{(Cl)=}3.0, and χ_{(F)=}4.0.

{(l/χ_{(S)})×[S²⁻]_{bulk}+(1/χ_{(O)})×[O²⁻]_{bulk}+(1/χ_{(Br)})×[Br⁻]_{bulk}+(1/χ_{(Cl)})×[Cl⁻]_{bulk}+(1/χ_{(F)})×[F⁻]_{bulk}}

Among the internal anion contents, [S²⁻]_{bulk} is a value obtained by normalizing a value obtained by {(content of S detected)−(content of P detected)×4}, similar to [S²⁻]₀ among the surface anion contents. When the value obtained by the above expression is less than 0, that is, a negative value, [S²⁻]_{bulk}=0. The contents of S and P detected are contents obtained by composition analysis.

Each of [O²⁻]_{bulk}, [Br⁻]_{bulk}, [Cl⁻]_{bulk}, and [F⁻]_{bulk} is a value obtained by the following equation by taking the content of each element obtained by the composition analysis as the detected content.
[O²⁻]_{bulk}=(content of 0 detected)/normalizing value
[Br⁻]_{bulk}=(content of Br detected)/normalizing value
[Cl⁻]_{bulk}=(content of Cl detected)/normalizing value
[F⁻]_{bulk}=(content of F detected)/normalizing value

The normalizing value is a value adjusted to satisfy [S²⁻]_{bulk}+[O²⁻]_{bulk}+[BC]_{bulk}+[Cl⁻]_{bulk}+[F⁻]_{bulk}=1.

### (Lithium Ion Conductivity)

The sulfide solid electrolyte was pulverized in a mortar, coarse particles were removed through a mesh pass having an opening of 100 m, and 100 mg of the particles were weighed. Next, the lithium ion conductivity of the measurement sample was measured by using an AC impedance measuring device (potentiostat/galvanostat VSP, manufactured by Bio-Logic Sciences Instruments) while pressure-molding the measurement sample having an area of 10 mm in diameter at 380 MPa.

The measurement conditions were as follows: a measurement frequency of 100 Hz to 1 MHz, a measurement voltage of 100 my, and a measurement temperature of 25° C.

The results are shown in “σ_{Li+}(mS/cm)” in “Evaluation” in Table 1.

(Particle Diameter Measurement) A particle diameter distribution was measured by using a laser diffraction particle diameter distribution analyzer MT 3300 EXII manufactured by Microtrac, and the average particle diameters D₁₀, D₅₀, and D₉₀ were measured based on a chart of the obtained volume-based particle diameter distribution.

### (Battery Characteristic)

The sulfide solid electrolyte was dry-pulverized under a dry nitrogen atmosphere by using an alumina ball having a particle diameter of 2 mm in a planetary ball mill (model number LP-M2, manufactured by Ito Seisakusho Co., Ltd.). Next, the powder was passed through a sieve having an opening of 43 μm to obtain a sulfide solid electrolyte powder having a particle diameter distribution with an average particle diameter D₅₀ of 3 μm.

A layered rock-salt NMC 811 powder (manufactured by MTI Corporation, volume average particle diameter: 11.75 m) was used as a positive electrode active material, and 34 parts by mass of the sulfide solid electrolyte powder prepared above, 60 parts by mass of the positive electrode active material, and 6 parts by mass of a conductive aid (acetylene black, manufactured by Denka Company Limited, HS 100) were mixed to prepare a positive electrode mixture.

Into a plastic cylinder having a diameter of 10 mm was charged 80 mg of the sulfide solid electrolyte powder prepared above and pressure-molded to form a solid electrolyte layer. Next, 6 mg of the positive electrode mixture prepared above was charged into the same cylinder, and pressure molding was performed again to form a positive electrode layer. Further, an indium foil and a lithium foil were charged from the side opposite to the positive electrode mixture to form a negative electrode layer. An all-solid-state lithium-ion secondary battery was prepared in this manner, and a charge and discharge test was performed at a confining pressure of 10 kN.

In the charge and discharge test, a constant current charge and discharge test was conducted for 5 cycles under the following conditions: measurement temperature: 25° C., charge current density: 0.05 C, discharge current density: 0.05 C, and charge and discharge potential range: 1.9 V to 3.7 V.

From the results of the charge and discharge test, the initial characteristic and capacity retention ratio (%) represented by the following equations were determined, and the battery characteristic of the all-solid-state lithium-ion secondary battery was evaluated.

Initial characteristic=(discharge capacity in first cycle/charge capacity in first cycle)

Capacity retention ratio (%)=(discharge capacity in fifth cycle/discharge capacity in first cycle)×100

The battery characteristic was evaluated according to the following criteria. The results are shown in the item of “Battery characteristic” in “Evaluation” in Table 1. The initial characteristic and the capacity retention ratio are expressed as relative values when the initial characteristic and the capacity retention ratio in Example 5 are taken as 1. Since Example 5 was used as a reference for relative evaluation, the “battery characteristic” in Table 1 is indicated by “-”.
A: Both initial characteristic of 1.1 or more and capacity retention ratio of 1.05 or more are satisfied.
B: Both initial characteristic and capacity retention ratio were more than 1.0, and one of initial characteristic of more than 1.0 and less than 1.1 and capacity retention ratio of more than 1.0 and less than 1.05 is satisfied.
C: At least one of initial characteristic of 1.0 or less and capacity retention ratio of 1.0 or less is satisfied.

TABLE 1

| | Bulk composition | | | | | |
|---|---|---|---|---|---|---|
| | Anion content | | | | | Internal anion |
| | [S²⁻]_{bulk} | [O²⁻]_{bulk} | [Br⁻]_{bulk} | [Cl⁻]_{bulk} | [F⁻]_{bulk} | parameter |
| Example 1 | 0.04 | 0.17 | 0.38 | 0.34 | 0.07 | 0.33 |
| Example 2 | 0.04 | 0.17 | 0.38 | 0.34 | 0.07 | 0.33 |
| Example 3 | 0.03 | 0.20 | 0.37 | 0.34 | 0.06 | 0.33 |
| Example 4 | 0.03 | 0.18 | 0.38 | 0.41 | 0.00 | 0.34 |
| Example 5 | 0.03 | 0.18 | 0.38 | 0.41 | 0.00 | 0.34 |

| | Surface composition | | | | | |
|---|---|---|---|---|---|---|
| | Anion content | | | | | Surface anion |
| | [S²⁻]₀ | [O²⁻]₀ | [Br⁻]₀ | [Cl⁻]₀ | [F⁻]₀ | parameter |
| Example 1 | 0.02 | 0.36 | 0.26 | 0.31 | 0.05 | 0.32 |
| Example 2 | 0.00 | 0.48 | 0.22 | 0.26 | 0.04 | 0.31 |
| Example 3 | 0.00 | 0.48 | 0.22 | 0.26 | 0.04 | 0.32 |
| Example 4 | 0.00 | 0.50 | 0.21 | 0.25 | 0.00 | 0.30 |
| Example 5 | 0.09 | 0.17 | 0.39 | 0.35 | 0.00 | 0.34 |

| | Evaluation | |
|---|---|---|
| | σ_{Li+} (mS/cm) | Battery characteristic |
| Example 1 | 8.3 | B |
| Example 2 | 5.5 | A |
| Example 3 | 10.5 | A |
| Example 4 | 4.6 | A |
| Example 5 | 9.9 | — |

In the sulfide solid electrolytes of Example 1 to Example 4, the surface anion parameter was 0.33 or less, the battery characteristic was good, and the degradation in battery characteristics during repeated charging and discharging can be prevented. On the other hand, the sulfide solid electrolyte of Example 5 had a high surface anion parameter and a poor battery characteristic.

Although the present invention has been described in detail with reference to specific embodiments, it is apparent to those skilled in the art that various changes and modifications can be made without departing from the spirit and scope of the present invention. The present application is based on a Japanese Patent Application (No. 2021-161522) filed on Sep. 30, 2021, and the contents thereof are incorporated herein by reference.

What is claimed is:

1. A sulfide solid electrolyte to be used for a lithium-ion secondary battery, the sulfide solid electrolyte comprising:
an argyrodite crystal containing Li, P, S, and Ha, wherein
the Ha represents at least one element selected from the group consisting of F, Cl, Br, and I, including at least one of Cl and Br, and
the following relationships are satisfied, where [S²⁻]₀, [0²⁻]₀, [Br⁻]₀, [Cl⁻]₀, and [F⁻]₀ are surface anion contents of the sulfide solid electrolyte, and χ₍ₛ₎, χ₍ₒ₎, χ_{(Br)}, χ_{(CL)}, and χ_{(F)} are electronegativities thereof:
{(1/χ_{(S)})×[S²⁻]₀+(1/χ_{(O)})×[O²⁻]₀+(1/χ_{(Br)})×[Br⁻]₀+(1/χ_{(Cl)})×[C-1]₀+(1/χ_{(F)})×[F]₀}<0.33, and
[S²⁻]₀+[O²⁻]₀+[Br⁻]₀+[Cl⁻]₀+[F⁻]₀=1.

2. The sulfide solid electrolyte according to claim 1, wherein
the sulfide solid electrolyte contains O and F.

3. The sulfide solid electrolyte according to claim 1, wherein
the sulfide solid electrolyte contains 0, and
the [O²⁻]₀ among the surface anion contents is 0.3 or more.

4. The sulfide solid electrolyte according to claim 1, wherein
the sulfide solid electrolyte contains F, and
the [F⁻]₀ among the surface anion contents is 0.02 or more.

5. The sulfide solid electrolyte according to claim 1, wherein
the value represented by {(1/χ(S))×[S²⁻]₀+(1/χ_{(O)})×[O²⁻]₀+(1/χ_{(Br)})×[Br⁻]₀+(1/χ_{(Cl)})×[Cl⁻]₀+(1/χ_{(F)})×[F⁻]₀} is 0.31 or less.

6. The sulfide solid electrolyte according to claim 1, wherein
the sulfide solid electrolyte has a particle diameter D₅₀ of 0.6 μm or less.

7. The sulfide solid electrolyte according to claim 1, wherein
the following relationship is satisfied, where D₁₀, D₅₀, and D₉₀ are particle diameters of the sulfide solid electrolyte:
2.0<{(D₁₀+D₉₀)/D₅₀}<4.5.

8. The sulfide solid electrolyte according to claim 1, wherein
five or more kinds of internal anions are present in the sulfide solid electrolyte.

9. The sulfide solid electrolyte according to claim 1, wherein
the sulfide solid electrolyte contains 0,
[S²⁻]_{bulk}+[O²⁻]_{bulk}+[Br⁻]_{bulk}+[Cl⁻]_{bulk}+[F⁻]_{bulk}=1 is satisfied, where [S²⁻]_{bulk}, [O²⁻]_{bulk}, [Br⁻]_{bulk}, [Cl⁻]_{bulk}, and [F⁻]_{bulk} are internal anion contents of the sulfide solid electrolyte, and
the [O²⁻]₀ among the surface anion contents is larger than the [O²⁻]_{bulk} among the internal anion contents, and a difference thereof is 0.2 or more.

10. The sulfide solid electrolyte according to claim 1, wherein
[S²⁻]_{bulk}+[O²⁻]_{bulk}+[Br⁻]_{bulk}+[Cl⁻]_{bulk}+[F⁻]_{bulk}=1 is satisfied, where [S²⁻]_{bulk}, [O²⁻]_{bulk}, [Br⁻]_{bulk}, [Cl⁻]_{bulk}, and [F⁻]_{bulk} are internal anion contents of the sulfide solid electrolyte, and
a value represented by {(1/χs))×[S²⁻]_{bulk}+(1/jo))×[O²⁻]_{bulk}+(1/χ_{(Br)})×[Br⁻]_{bulk}+(1/χ_{(Cl)})×[Cl⁻]_{bulk}+(1/χ_{(F)})×[F⁻]_{bulk}} using the internal anion contents and the electronegativities thereof χ_{(S)}, χ_{(O)}, χ_{(Br)}, χ_{(Cl)}, and χ_{(F)} is larger than the value represented by {(1/χ_{(S)})×[S²⁻]₀+(1/χ_{(O)})×[0²⁻]₀+(1/χ_{(Br)})×[Br⁻]₀+(1/χ_{(Cl)})×[Cl⁻]₀+(1/χ_{(F)})×[F]₀}, and a difference thereof is 0.01 or more.

11. The sulfide solid electrolyte according to claim 1, wherein
the surface anion contents satisfy a relationship of [0²⁻]₀>[S²⁻]₀.

12. The sulfide solid electrolyte according to claim 1, wherein
the surface anion contents satisfy a relationship of {[F⁻]₀/([Br⁻]₀+[Cl⁻]₀)}>0.02.

13. The sulfide solid electrolyte according to claim 1, wherein
an electromotive force of the lithium-ion secondary battery is 4.3 V or more.

14. A method for manufacturing a sulfide solid electrolyte to be used for a lithium-ion secondary battery, the method comprising:
mixing raw materials containing Li, P, S, and Ha to obtain a raw material mixture;
heating the raw material mixture to obtain a molten material as an intermediate compound;
cooling the molten material to precipitate an argyrodite crystal; and
subjecting the crystal to a heat treatment; wherein
in the crystal, S, at least one of Cl and Br, and one or two or more elements different from S and at least one of Cl and Br are present in an anion site, and
the heat treatment is performed under an atmosphere containing oxygen.

15. The method for manufacturing a sulfide solid electrolyte according to claim 14, wherein
an oxygen concentration in the heat treatment is 5 ppm to 5 vol %.

16. The method for manufacturing a sulfide solid electrolyte according to claim 14, wherein
a dew point in the heat treatment is −60° C. to −30° C.
